(19) United States
(12) Patent Application Publication
(10) Pub. No.: US 2014/0240511 A1
(43) Pub. Date: Aug. 28, 2014

(54) AUTOMATICALLY FOCUSING A SPECTRAL IMAGING SYSTEM ONTO AN OBJECT IN A SCENE

(71) Applicant: XEROX CORPORATION, Norwalk, CT (US)

(72) Inventors: Peter Johan NYSTROM, Webster, NY (US); Lalit Keshav MESTHA, Fairport, NY (US)

(73) Assignee: XEROX CORPORATION, Norwalk, CT (US)

(21) Appl. No.: 13/775,665

(22) Filed: Feb. 25, 2013

(51) Int. Cl. H04N 5/232

(52) U.S. Cl. CPC H04N 5/23296
USPC 348/164

(57) ABSTRACT

What is disclosed is a system and method for focusing a camera on an object of interest in a scene. In one embodiment, an illuminator comprising a light source which emits light at a desired wavelength band is aimed at an object in a scene. The source light beam impacts the object at an aim point. A spectral sensing device senses a reflection of the projected light beam off the object. In response to the reflected light beam having been detected by the spectral sensing device, a location of the object in the scene is determined and communicated to a video acquisition system. A focus of the video system is changed so that the object is brought into the camera's field of view. The object can be tracked as it moves about the scene. A spectral image of the object can be captured and analyzed for the object's material composition.

### TECHNICAL FIELD

The present invention is directed to systems and methods which, upon detection by a spectral sensing device of a reflection of a projected IR light beam off an object in a scene, a location of that object in the scene is determined and communicated to a video system which, in turn, automatically moves a focus of that video camera such that the identified object is brought into the camera's field of view.

### BACKGROUND

In high security environments such as an airport, for example, when a suspicious package being carried by a person as they walk around has been noticed by a security agent, the guard must then communicate with a person in a control booth somewhere who is responsible for controlling security cameras. The guard must then verbally describe the suspicious item or person. The person in the control booth then uses joysticks, for instance, to move a focus of one of their cameras such that the camera is then directed onto that person or package. Many instances the camera is directed onto the wrong person or the wrong package because the verbal description provided by the security guard to the person in the control booth was inadequate. Video images are then captured of the wrong item. Meanwhile, the person carrying that package proceeds through the security environment undetected. Accordingly, what is desirable in this art are increasingly sophisticated systems and methods for automatically focusing a video camera onto an object of interest identified in a scene.

### INCORPORATED REFERENCES

The following U.S. Patents, U.S. Patent Applications, and Publications are incorporated herein in their entirety by reference.
“Determining A Number Of Objects In An IR Image”, U.S. patent application Ser. No. 13/086,006, by Wang et al., which discloses a correlation method and a best fitting reflectance method for classifying pixels in an IR image.
“Determining A Total Number Of People In An IR Image Obtained Via An IR Imaging System”, U.S. patent application Ser. No. 12/967,775, by Wang et al, which discloses a ratio method for classifying pixels in an IR image.
“System And Method For Object Identification And Tracking”, U.S. patent application Ser. No. 13/247,343, by Xu et al., which discloses a system and method for analyzing a video to identify objects and to track those objects as they move across the scene.
“Post-Processing A Multi-Spectral Image For Enhanced Object Identification”, U.S. patent application Ser. No. 13/324,368, by Wang et al., which discloses a system and method for post-processing a multi-spectral image which has been pre-processed via a pixel classification method such that objects in the image are more correctly identified.
“Enabling Hybrid Video Capture of a Scene Illuminated with Unstructured and Structured Illumination Sources”, U.S. patent application Ser. No. 13/533,605, by Xu et al. which discloses a system for enabling hybrid video capture of a scene being illuminated with structured and unstructured illumination sources.
“Method For Classifying A Pixel Of A Hyperspectral Image In A Remote Sensing Application”, U.S. patent application Ser. No. 13/023,310, by Mestha et al., which discloses a system and method for simultaneous spectral decomposition suitable for image object identification and categorization for scenes and objects under analysis.
“Systems And Methods For Non-Contact Heart Rate Sensing”, U.S. patent application Ser. No. 13/247,575, by Mestha et al., which discloses a method for analyzing a video of a subject of interest to determine the subject's heart rate.
“Continuous Cardiac Pulse Rate Estimation From Multi-Channel Source Video Data”, U.S. patent application Ser. No. 13/528,307, by Kyal et al., which discloses systems and methods for continuously estimating cardiac pulse rate from multi-channel source video data.
“Minimally Invasive Image-Based Determination Of Carbon Dioxide (CO₂) Concentration In Exhaled Breath”, U.S. patent application Ser. No. 13/246,560, by Cardoso et al., which discloses systems and methods for an image-based monitoring of a patient's respiratory function such that a concentration of carbon dioxide (CO₂) in their exhaled breath as well as their respiration rate can be determined.
“Processing A Video For Vascular Pattern Detection And Cardiac Function Analysis”, U.S. patent application Ser. No. 13/483,992, by Mestha et al., which discloses a system and method for capturing video images of a region of exposed skin such as an arm, chest, neck, etc., of a subject of interest; analyzing that video to identify a vascular pattern in that region; and then processing the pixels associated with the identified vascular pattern to determine various cardiac functions of the subject.
“Monitoring Respiration With A Thermal Imaging System”, U.S. patent application Ser. No. 13/103,406, by Xu et al., which discloses a system and method which utilizes a thermal camera with single or multiple spectral bands to monitor respiration function.
“Video-Based Estimation Of Heart Rate Variability”, U.S. patent application Ser. No. 13/532,057, by Mestha et al., which discloses a system and method for estimating heart rate variability from video captured of a patient being monitored for cardiac function.
“Processing A Video For Respiration Rate Estimation”, U.S. patent application Ser. No. 13/529,648, Mestha et al., which discloses a system and method for estimating a respiration rate by analyzing distortions in reflections of structured illumination patterns captured in a video containing at least a partial view of a thoracic region of a patient being monitored for respiratory function.
“A Multi-Filter Array For A Multi-Resolution Multi-Spectral Camera”, U.S. patent application Ser. No. 13/239,642, by Xu et al., which discloses a multi-filter array for a multi-resolution and multi-spectral camera system for simultaneous spectral decomposition with a spatially and spectrally optimized multi-filter array suitable for image object identification.
“Reconfigurable MEMS Fabry-Perot Tunable Matrix Filter Systems And Methods”, U.S. Pat. No. 7,355,714, to Wang et al.
“Fabry-Perot Tunable Filter Systems And Methods”, U.S. Pat. No. 7,417,746, to Lin et al.

### BRIEF SUMMARY

What is disclosed is a system and method for automatically focusing a video camera onto an object of interest which has been identified in a scene. In one embodiment, an illuminator comprising a light source which emits light at a desired wavelength band is aimed at an object in a scene. The projected narrow light beam impacts the object at an aim point. A spectral sensing device senses a reflection of the projected beam off the object. In response to the reflected source light having been detected by the spectral sensing device, a location of the object in the scene is determined. The location is then communicated to a controller which, in turn, automatically moves a video camera such that the identified object is brought into the camera's field of view. In various embodiments hereof, video is captured of the object and processed so that the object is tracked as it moves about the scene. The location can be communicated to other devices such as a multi-spectral camera which proceeds to capture spectral images of the object. The spectral images are communicated to a workstation, for example, and analyzed to identify a material comprising that object. The location can be communicated to an imaging system and images captured of the person carrying the identified object so that, for instance, an amount of perspiration can be determined for that person. Other biometrics can also be automatically determined about that person such as, for example, their heart rate, respiration rate, an amount of Carbon Dioxide (CO₂) concentration in their exhaled breath, and various aspects of their cardiovascular system. Other devices can also receive the determined location, for example, a sound detection system such that audio recordings can be captured of that person or object as it moves about the scene.

The teachings hereof find their uses in a wide array of security environments such as, airports, courthouses, government buildings, to name a few, where video cameras are employed as a security measure and where there is a need to automatically redirect a focus of one or more of those video cameras and other devices onto an object of interest which has been identified in a scene. Many features and advantages of the above-described system and method will become apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 shows a scene of a person walking through, for example, an airport while pulling a wheeled luggage carrier behind them which contains various packages and a satchel for explanatory purposes;

FIG. 2 shows one embodiment of one example illumination system which projects a narrow source light beam onto an object of interest such as the satchel of FIG. 1;

FIG. 3 shows one embodiment of an example handheld illuminator which incorporates various aspects of the illumination system of FIG. 2, and which projects a narrow beam of source light of one or more desired wavelengths onto an object of interest in the scene of FIG. 1;

FIG. 4 shows an example spectral sensing device having a detector array which receives source light reflected off an object at an aim point, and which communicates a location of the identified object to a video acquisition system;

FIG. 5 shows one embodiment of an example video acquisition system which receives a location of the object from the spectral sensing device of FIG. 4 and which incorporates a controller for moving a focus of the video acquisition system such that video of the object can be acquired;

FIG. 6 shows one example security system configured in a high security environment such as an airport, wherein the spectral sensing device of FIG. 4 and the video acquisition system of FIG. 5 are used in accordance with various aspects of the teachings hereof;

FIG. 7 is a flow diagram of one embodiment of the present method for focusing a video camera onto an object of interest identified in a scene;

FIG. 8 is a functional block diagram of one embodiment of a system for performing various aspects of the present system and method as described with respect to the spectral sensing device of FIG. 4, the security system of FIG. 6, and the flow diagram of FIG. 7; and

FIG. 9 shows a functional block diagram of one embodiment of an example video control system 900 for performing various aspects of the present system and method as described with respect to the video acquisition system of FIG. 5, the security system of FIG. 6, and the flow diagram of FIG. 7.

### DETAILED DESCRIPTION

What is disclosed is a system and method for automatically focusing a camera on an object of interest which has been identified in a scene. The teachings hereof find their uses in a wide array of security environments such as, airports, courthouses, government buildings, to name a few, where video cameras are employed as a security measure and where there is a need to automatically redirect a focus of one or more of those video cameras and other devices onto an object of interest which has been identified in a scene.

### Non-Limiting Definitions

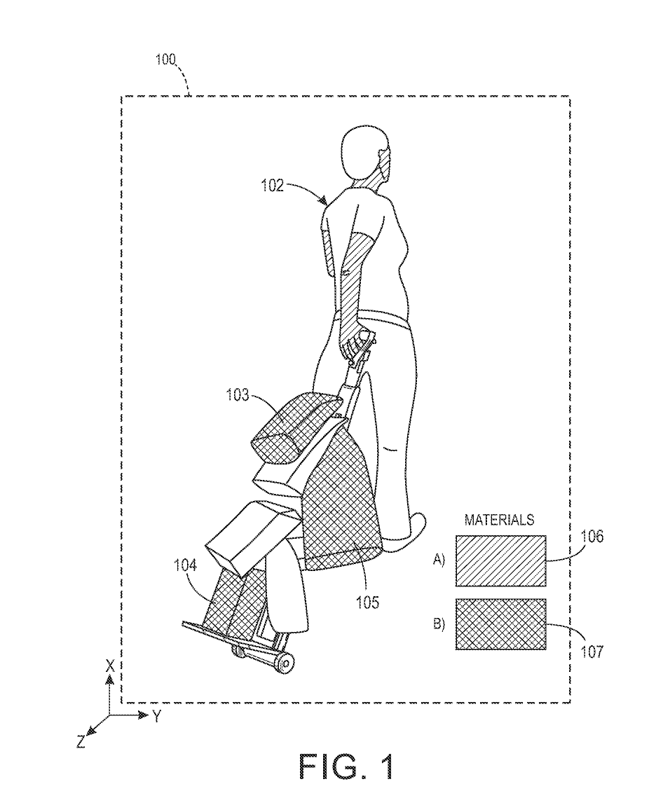

An “object of interest” can be any object in a scene which is intended to be captured by a video camera such that the object can be tracked as it moves about that scene. Reference is now being made to FIG. 1 which shows an example scene 100 of a person 102 pulling a wheeled luggage carrier containing packages 103 and 104 and a satchel 105. Any of the objects, including person 102, in any given scene may comprise the object of interest. In various embodiments hereof, spectral images of the scene are analyzed for material identification. Example results of material analysis having been performed on the spectral image of scene 100 are shown as material ‘A’ (at 106) identified as human skin tissue and material ‘B’ (at 107) identified as a material comprising packages 103 and 104 and satchel 105. An object of interest is identified in a scene using an illuminator.

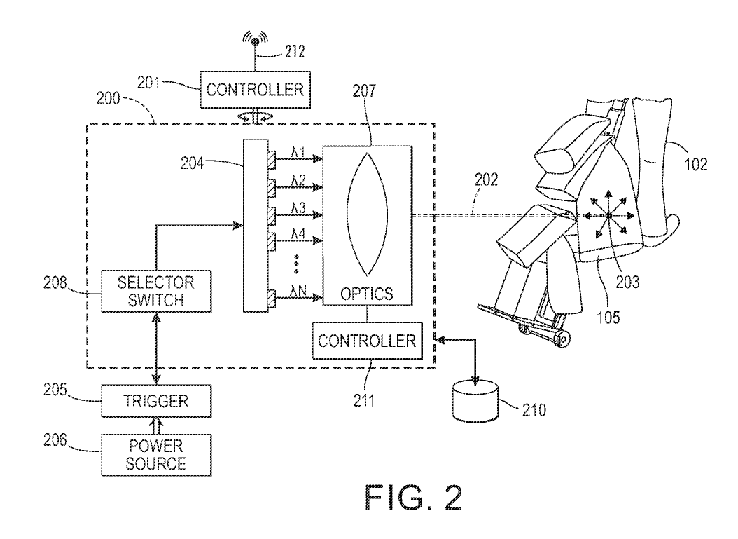

An “illuminator” refers to a device which projects light source at a desired wavelength band through an optical element which focuses that light into a narrow beam. One example illumination system is shown and discussed with respect to FIG. 2.

A “spectral image” is an image comprising pixels which respectively contain spectral information. Each pixel in a spectral image has an associated intensity value measured in terms of a captured reflectance centered about a detected wavelength band. Spectral images are captured using a spectral sensing device.

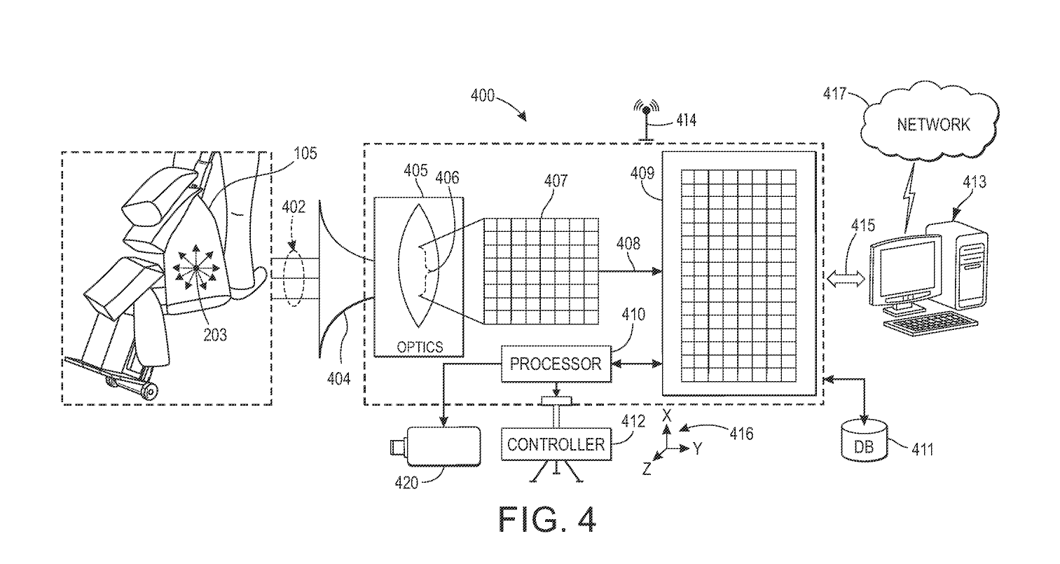

A “spectral sensing device” is a device which has optics for focusing reflected light onto an array of detectors comprising a plurality of sensors which are sensitive to a wavelength range of the source light projected by the illuminator. A spectral sensing device can be a custom-made device having only a few specialized sensors or it can be, for example, a multispectral or hyperspectral imaging system. Multi-spectral imaging systems capture 2D images comprising non-contiguous spectral planes. Whereas, hyperspectral imaging systems capture images comprising contiguous spectral planes which are processed into a hyperspectral image data cube comprising a 3D matrix constructed of a combination of 2D image data and 1D spectral components. The 2D image data is an array of pixels with each pixel location having a reflectance value centered about a wavelength of interest. Various spectral sensing devices further incorporate filter arrays such as, for example, a Fabry-Perot filter which restricts the capture of spectral data to desired wavelength bands while rejecting wavelengths outside that band. One example spectral sensing device is shown and discussed with respect to FIG. 4.

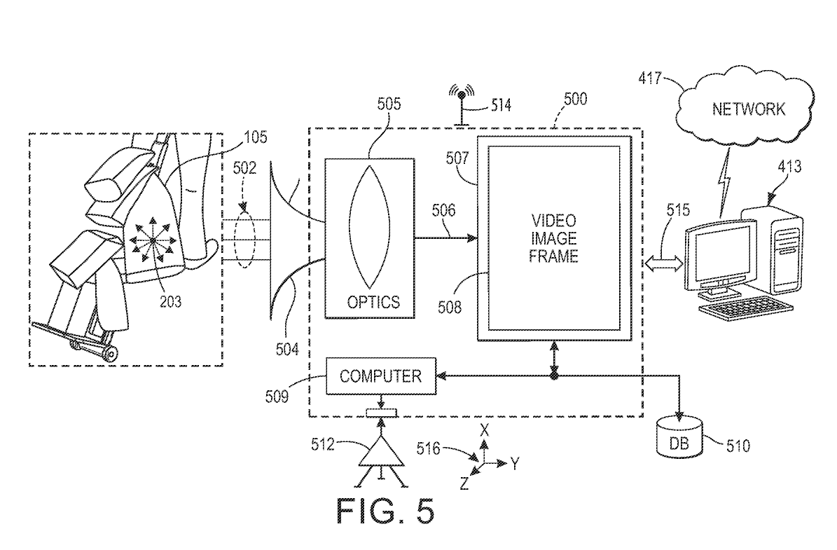

A “video acquisition system” refers to a video capture device, such as a video camera as is generally understood, that is sensitive to the visible wavelength range or the infrared wavelength range. The video acquisition system may comprise a multi-channel video capture device capable of operating in overlapping wavelength bands in one or both of the visible and infrared bands. One example video acquisition system is shown and discussed with respect to FIG. 5.

“Moving a focus of a device”, as used herein, means changing a direction at which optics of that device receive reflected light. Changing the focus of a video camera would bring an object of interest into the camera's field of view. In various embodiments hereof, the focus of a device is changed so that an aim point is approximately centered about the device's field of view.

An “aim point” refers to the point at which the narrow beam of projected source light impacts an object or person. Projected source light reflects off the person or object at the aim point. An example aim point is shown at 203 of FIG. 2.

### Example Illumination System

Reference is now being made to FIG. 2 shows one embodiment of one example illumination system which projects a narrow source light beam onto an object of interest such as the satchel of FIG. 1.

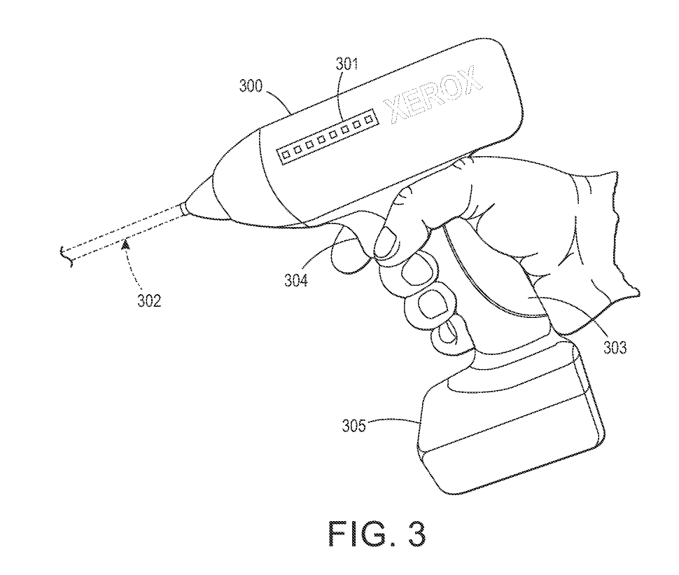

In FIG. 2, the projected narrow light beam impacts the surface of the satchel 105 at aim point 203. The satchel, in this example, becomes the object of interest. The IR illumination system 200 is shown comprising a plurality of infrared (IR) light sources 204 each emitting a wavelength band of source light at a respective peak wavelength (λ₁, . . . , λₙ). In one embodiment, the array of light sources 204 comprises a plurality of IR light emitting diodes (LEDs) with each diode in the array having been pre-selected to emit light at a respective peak wavelength. When pressed by a user, light activation trigger 205 electrically couples power source 206 to the array of light sources. Movement of the trigger 205 controls an amount of input current which is applied to the illuminators and thereby the output intensity of the light source being projected by each. Various aspects of the light sources are controlled by a selector switch 208. In one embodiment, the selector switch comprises a plurality of selectable DIP switches which turn ON/OFF various LEDs pre-configured to each emit IR radiation at a desired peak wavelength. The selectable switch 208 enables the wavelength of the source light projected by the illumination system to be selectable. Optical element 207 may include a plurality of lens of varying focal lengths positioned in the beam path to focus the emitted source light into a narrow IR illumination beam 202. Optical element 207 may further comprise one or more controllers 211 coupled thereto which manipulate various components of the optics to effectuate a change in the projected beam 202, for example, to pulse the beam. Such a change may be desirable due to, for example, target size, target distance, the configuration of the spectral sensing device employed, to name a few. Any of the optics described with respect to the IR illumination system 200 can be replaced with a computer controlled optical system and may further include mirrors or other reflective surfaces. Controller 201 is shown for those embodiments of FIG. 3 where it is desirable to have the illuminator 200 rotatably mounted such that a direction at which the narrow light beam 202 is projected can be changed by a movement of the illuminator. A direction at which the narrow beam 202 is to be projected would be, for example, received by antenna 212 from a remote device.

Any of the controllers, switches, optics, illuminators, and other components of the illumination system of FIG. 2 may comprise a specialized circuit such as an ASIC with a computer processor executing machine readable program instructions, and further may be placed in wired or wireless communication with a computing workstation over a network such as, for example, workstation 413 of FIG. 4, to facilitate the intended purposes thereof. Various components of the illumination system of FIG. 2 may further be placed in communication with a storage device 210 wherein device calibration information, default and user-selected settings, configuration information, and the like, are stored and retrieved. Machine readable program instructions for performing any of the features and functionality of the system of FIG. 3 may also be retrieved from the storage device.

### Example Handheld Illuminator

Reference is now being made to FIG. 3 shows one embodiment of an example handheld illuminator 300 which incorporates various aspects of the illumination system of FIG. 2, and which projects a narrow beam of source light of one or more desired wavelengths onto an object of interest in the scene of FIG. 1.

The handheld device of FIG. 3 projects a narrow light beam 302 which impacts, for example, the satchel 105 of FIG. 1 at aim point 203. The wavelength of the projected beam is at a desired peak wavelength which has been configured by selector switch 301. To activate the illuminator pointing device 300, a user thereof grips handle 303 and uses a finger to press trigger 304 which electrically connects power from battery 305 to the light emitting diodes (internal to the handheld device). Although the embodiment of FIG. 3 shows the illuminator being powered by a battery pack 305, it should be appreciated that such a device may be powered by an electrical cord (not shown) plugged into an electrical outlet. In other embodiments, the illuminator 300 may be configured to project source light through a patterned grid or window having known spatial characteristics. Such a pattern may be, for instance, a pseudo-random pattern with known spatial characteristics such that 3D surface profiles of the object of interest can be computed using structured-light principles and triangulation-based image reconstruction techniques that are well established. It should be appreciated that the handheld device of FIG. 3 is illustrative and that the illuminator may be a smaller device such as, for instance, a laser pointer which may not be much larger than a pencil such that the laser point can be carried by a security agent in a breast pocket and retrieved when needed. When a security guard or agent sees an object of interest in a scene, they would retrieve the laser pointing pen from their pocket and press a switch thereon to activate the pointer. A narrow beam of light would then be projected therefrom. The security agent would then aim the projected light beam onto an object or person. The projected light beam contacts the object/person at an aim point, and a reflection thereof is automatically sensed by a spectral sensing device.

### Example Spectral Sensing Device

Reference is now being made to FIG. 4 shows an example spectral sensing device 400 having a detector array which receives source light reflected off an object at an aim point, and which communicates a location of the identified object to a video acquisition system.

Reflected source light 402 enters the spectral sensing device 400 through an aperture 404 and passes through optics 405. In the embodiment of FIG. 4, the optics direct the received source light 406 through an array of filter elements 407 which only permit desired wavelength bands 408 to pass through onto an array of detectors 409. Individual sensors comprising the detector array (shown as a uniform grid) are sensitive to the pea wavelengths selected for the illuminator 300. The sensors in the detector array detect a reflection of the projected source light. Upon detection, detector array 409 communicates the received spectral data to processor 410 which executes machine readable program instructions retrieved from storage device 411. Processor 410 signals controller 412 to rotatably move sensing system 400 in any of an x, y, and z axis (at 416). When the spectral sensing device is moved such that aperture 404 is pointed in the direction of the aim point on the identified object of interest, the sensors of the detector array will detect a peak intensity of the wavelength(s) of the received source light 402. As the aperture is moved away from the aim point, the amount of reflected source light entering the sensing device will be less and the intensity values detected by the sensors will decrease. Based upon a final direction of the sensing device as determined by x,y,z positional data received by processor 410 from controller 412, an instant location of the direction at which the spectral sensing device is pointing can be determine. Processor 410 then signals to emitter 420 to obtain a distance the object is from the spectral sensing device. The processor uses the obtained distance and the x,y,z location information from the controller to calculate a location of the object. In another embodiment, the location of the object is automatically determined by processor 410 using the x,y,z positional information of the controller in conjunction with various locations of known objects in the scene such as walls, doorways, and the like, which have been pre-programmed and stored in storage device 411 for use by the processor. In such a manner, an instant location of the object is determined. The determined instant location of the aim point (and thus the location of object itself) is then automatically transmitted to the video acquisition system of FIG. 5 using, for instance, the communication element 414 (shown as an antenna). As explained herein in further detail with respect to FIG. 5, upon receipt of the determined location by the video acquisition system, a controller thereof moves a focus of the video acquisition system so that the aim point is approximately centered in the field of view of that video capture device.

In other embodiments, processor 410 repeatedly determines an instant location of the aim point as the object moves about the scene and, in turn, provides a continuously updated signal to controller 412 to keep moving a focus of the spectral sensing device 400 such that the spectral sensing device is continually pointed at the object. In such a manner, the object can be followed by the spectral sensing device as the object moves about the scene. It should be appreciated that this alternative embodiment relies on a continuous projection of the source light beam at the aim point. In this embodiment, the spectral sensing device 400 is in communication with a separate illumination system wherein, upon determination of the location of the aim point, the processor 410 communicates the determined instant location of the aim point to a controller 201 of FIG. 2 which receives the location at which to project the narrow light beam via communication element 212. The illumination system then rotates to point in the desired direction and proceeds to project its narrow light beam in the direction of the determined aim point. Working in conjunction with such an illuminator, the spectral sensing device 400 can continuously track the object as it moves about the scene. As soon as a projection of the source light from the illumination source ceases, the spectral sensing device no longer detects the reflected source light and thus can no longer determine a location of the aim point. In which case, the spectral sensing device 400 assumes a default mode wherein it randomly scans the scene awaiting detection of a next reflection of the projected source light off another object of interest.

In yet another embodiment of the spectral sensing device of FIG. 4, spectral images are captured by the detector array 409 or by another spectral imaging system. The captured spectral images are communicated to workstation 413 wherein intensity values of pixels comprising the spectral image(s) are analyzed such that a material comprising the object identified at the aim point can be identified. Materials may be identified using, for example, a pixel classification technique as disclosed in the above-incorporate reference entitled: “Method For Classifying A Pixel Of A Hyperspectral Image In A Remote Sensing Application”, Mestha et al. The spectral image may be post-processed using, for example, techniques disclosed in the above-incorporated reference entitled: “Post-Processing A Multi-Spectral Image For Enhanced Object Identification”, by Wang et al. Spectral images can be pre-processed for relative shift due to the location of each filter band within the filter. Camera-to-object distance can also be corrected, if needed. Intensity values associated with pixels of the captured spectral images can be re-scaled based on known sensor response(s) with respect to each detected wavelength band. Processed images may be communicated to the workstation for display thereon using, for example, a split-screen format such that an operator thereof can visually monitor objects/persons moving in the scene. Appropriate security measures can additionally be taken.

Various elements of the spectral sensing device of FIG. 4, including processor 410, storage device 411, controller 412, and sensor elements of detector array 409 may be placed in communication (at 415) with workstation 413. The system of FIG. 4 may further be placed in communication with one or more remote devices over network 417. Such a network may be a local area network (LAN), intranet, or the Internet. Communication with various devices over network 417 may be wired or wireless and may utilize Tx/Rx antenna 414. Data is transferred between devices in the form of signals which may be, for example, electronic, electromagnetic, optical, light, or other signals, by means of a wire, cable, fiber optic, phone line, cellular link, RF, satellite, or other medium or communication protocol or pathway. Communication element 414 may be configured to place any of the components of the spectral sensing device in communication with workstation 413. Workstation 413 may receive the determined location of the aim point from processor 410 such that a change in the focus of the video acquisition system of FIG. 5, can be effectuated. The workstation may also execute machine readable program to facilitate a determination of a location of the aim point.

It should be understood that the determined aim point location may also be communicated to controllers associated with various other devices such as, for example, one or more multi-spectral or hyperspectral imaging systems placed throughout the scene which capture spectral images of the object from different perspectives as the object moves about. In this embodiment, the captured spectral images are communicated to workstation 413 which analyzes the images to determine information about the object which may be in addition to identifying a material comprising the object. In these embodiments, the video acquisition system comprises one or more multi-spectral or hyperspectral imaging systems.

The determined location of the aim point may further be communicated to one or more thermal imaging systems which capture thermal images of the person carrying the identified object. The thermal images are communicated to workstation 413 and analyzed to obtain different biometrics about the person carrying the identified object of interest such as, for instance, an amount of perspiration. Other biometrics which can also be automatically determined by an analysis of thermal images include their heart rate, respiration rate, an amount of Carbon Dioxide (CO₂) concentration in their exhaled breath, and various information about their cardiac function and cardiovascular system. In these embodiments, the video acquisition system comprises a thermal video camera.

Other devices can also receive the determined location, for example, a sound detection system with a parabolic microphone rotatably mounted on a controller for sensing audio of that person as they move about the scene. In this embodiment, parabolic microphones would be placed throughout the scene at various locations and would track and capture audio recordings of the person 102, for example, talking on their cellphone or speaking to another person or perhaps to themselves. The sound system would also be able to obtain audio recordings of any noise being made by the object of interest identified by the aim point such as, for example, a ticking noise which may indicate the presence of an explosive device or a detonation system. Such a sound detection device may be used in conjunction with various configurations of the video acquisition system, as described herein, depending on the implementation.

### Example Video Acquisition System

Reference is now being made to FIG. 5 which shows one embodiment of an example video acquisition system 500 which receives a location of the object from the spectral sensing device 400 of FIG. 4.

Source light from, for example, the handheld illuminator of FIG. 3, reflects off the satchel 105 being pulled by the person in the scene of FIG. 1. The projected source light 302 reflects off the satchel at aim point 203. The reflected source light 502 enters the video acquisition system through aperture 504 and passes through optics 505 which directs the received source light 506 onto a detector array 507 comprising a plurality of sensors arrayed on a grid which resolve the reflected source light to form image frames 508 collectively comprising a video of the object. The image frames 508 of the video are communicated to a computer system 509 which, in this embodiment, is shown being internal to the system of FIG. 5. The computer processor 509 retrieves and executes machine readable program instructions as needed to process the acquired image frames in accordance with various embodiments hereof. Storage device 510 may be used to store image frames, time data, location information, and the like. The storage device may further store machine readable program instructions, formulas, variables, functions, and the like. Although shown as an external device, storage device 510 may be entirely internal to the video acquisition system.

Upon receipt of the determined location of the aim point from the spectral sensing device (or from workstation 413 depending on the embodiment), computer 509 signals controller 512 to rotatably move the focus of the camera along any of an x, y, and z axis (at 516) to change a direction thereof such that a video of the identified object can be acquired as the object. The captured video is processed, in real-time, using object tracking techniques known in the arts. One such method is disclosed in the above-incorporated reference entitled: “System And Method For Object Identification And Tracking”, by Xu et al. which discloses a system and method for analyzing a video to identify objects and to track those objects as they move across the scene. Location of the object being tracked can also be obtained by the object tracking method and communicated to one or more devices in the scene such as, for instance, the spectral sensing device 400 or other imaging systems placed throughout the scene so that these devices can, in turn, also track the person or object as they move about.

Various elements of the video acquisition system of FIG. 5, including computer 509, storage device 510, controller 512, and the detector array 507 may be placed in communication (at 515) with workstation 413. The workstation may function, in part, to provide instructions to the controller 512 to move the focus of the video acquisition system such that the aim point is brought into the camera's field of view. The system of FIG. 5 may further be placed in communication with one or more devices over network 417 using, for example, various functionality of Tx/Rx element 514 (shown as an antenna).

In various embodiments hereof, an instant location of the aim point is determined by the spectral sensing device 400 in a manner discussed and that location is communicated to the controller of the video acquisition system of FIG. 5 which, in turn, focuses the video camera on that object and proceeds to capture video thereof. The image frames of the video are analyzed in real-time using object tracking techniques with a continuous location of the object being determined therefrom and communicated, in real-time, to one or more other devices positioned a various locations throughout the scene. Controllers associated with each of these devices, in turn, receive the continuously updated location information and focus or re-focus their respective devices onto the identified object of interest and proceed to capture spectral images, thermal images, and/or audio recordings of the object to be analyzed.

Controller 512 of FIG. 5 and the controller 412 of FIG. 4 may be the same controller in those embodiments, for instance, where the sensing device of FIG. 4 and the video acquisition system of FIG. 5 comprise a single device or are housed in a signal unit such that a movement of one device effectuates a movement of the other such that both devices move in unison.

In yet another embodiment, the workstation 413 is in operative communication with the controllers of various different image acquisition and sound detection devices located at various positions throughout the scene. Workstation 413 provides each with updated location information. Workstation 413 may automatically controls the focuses thereof, respectively, from a single location via each devices Tx/Rx antenna. The workstation may also receive the images, sounds, and other data captured by each respective device throughout the scene and process that data either separately or in parallel. The results thereof may further be gathered, consolidated, and displayed on one or more display devices for a user review thereof.

In yet other embodiments, workstation 413 is further configured to automatically process results of the various acquired and analyzed data received from the devices capturing data of the object such as, for example, a material determined to comprise the object, and cross-references those results with information contained in a database. An alert signal is automatically issued if certain conditions are triggered. For example, if the material determined to comprise the object of interest is matched to a known explosive material then the workstation would issue a pre-established security protocol which may include a notification. Such a notification may take the form of a canned audio message or, for instance, a siren being activated, or initiating a light which provides a visual alert such as, for instance, a flashing light. The notification may comprise a message such as a text, audio, and/or video message which is automatically played indicated the nature of the alert to, for example, a supervisor. The notification may be transmitted in the form of an email, phone, or text message sent to one or more persons to advise them that a security condition has been triggered and that action is required. The workstation may further initiate a lockdown of the secure environment by automatically closing doors and locking them such that the object or person is contained.

### Example System Configuration

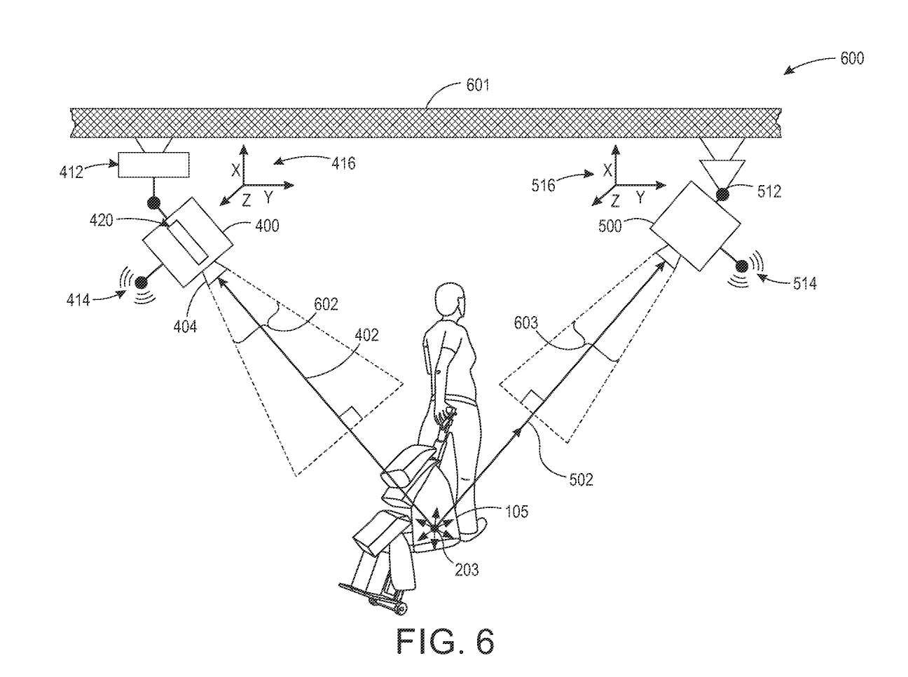

Reference is now being made to the system 600 of FIG. 6 which shows one example security system configured in a high security environment such as an airport, wherein the spectral sensing device of FIG. 4 and the video acquisition system of FIG. 5 are used in accordance with various aspects of the teachings hereof.

Person 102 is walking through a secure environment pulling satchel 105 behind them on a wheeled luggage carrier. The laser pointing device 300 of FIG. 3 has been used by a security agent to identify the satchel as an object of interest. The narrow light beam projected by the handheld illuminator has impacted the satchel at aim point 203. Reflected source light 402 has been detected by the spectral sensing device 400 which is sensitive to a wavelength band of the projected narrow light beam 302. The spectral sensing device 400 is rotatably mounted on a spindle controlled by a controller 412 fixed to ceiling 601. The controller can change a direction of the focus of the sensing device 400 along the x, y, z axis (at 416) such that a direction at which the device receives reflected source light 402 can be changed.

The sensors in the detector array 409 have detected the reflected source light 402. Controller 412 has rotated the focus of the spectral sensing device 400 such that aim point 203 is approximately centered in the field of view 602. Processor 410 determines an instant location of aim point 203 and Tx/Rx element 414 communicates the determined location to video acquisition system 500 which receives the location via antenna 514. The video acquisition system is also rotatably mounted on a controller 512 that is fixed to ceiling 601. As discussed with respect to FIG. 5, computer 509 receives the transmitted location of the computed instant aim point and signals controller 512 to change a direction of the focus of the video acquisition system such that the aim point 203 is approximately centered in the camera's field of view 603. Video acquisition system captures a plurality of image frames of the object. It should be appreciated that field of view 602 and field of view 603 may encompass a larger or smaller portion of the scene depending on the configured fields of view and the nature of the security concerns wherein the systems and methods disclosed herein find their intended uses. The captured video is transmitted via antenna 514 to workstation 413 wherein the image frames comprising the video are processed. The object is identified in the video, a location thereof determined, and the object is tracked by the video camera as it moves about the scene.

The video of the object may be displayed on a monitor of workstation 413 for review by an operator thereof. The operator may use the workstation in real-time to control various algorithms used to process the video which may include selecting one or more menu options displayed thereon. Selectable menu options may, for example, enable the operator to zoom the video camera such that the object is enlarged in the video. The user may highlight one or more other objects in the video including the face of the person 102 pulling the wheeled carrier containing the object of interest. Facial recognition software may further be employed to facilitate an identification of the person. The field of view of the video camera may be controllable by the user using menu options selectable on the display of the workstation. Various components of the video acquisition system may also be changed by the user such as a focus of the camera's lens, switching filters, and the like. The workstation 413 may further provide the operator with similar functionality with respect to the spectral sensing device 400. The user may further control various structured and un-structured illumination sources placed throughout the scene, as needed. Other controllers (not shown) internal to either the spectral sensor device or the video acquisition system may receive signals and execute other program instructions to change or otherwise modify various aspects of either device in response to a user-initiated event.

Spectral sensing device 400 may further communicate the determined location of the aim point to one or more spectral cameras which may also be rotatably mounted to ceiling 601 such that multiple spectral images of the object or person can be captured simultaneously or sequentially from differing perspectives. A plurality of video camera systems may be attached to the ceiling or walls throughout various locations within the security environment. These devices may also receive the determined location of the aim point from the spectral sensing device 400 with each device capturing various still or time-sequenced images in different formats. These additional image capture devices may also transmit their respective images to workstation 413 for parallel processing such that different aspects about the identified object and/or person carrying those object(s) can be simultaneously obtained.

### Example Flow Diagram

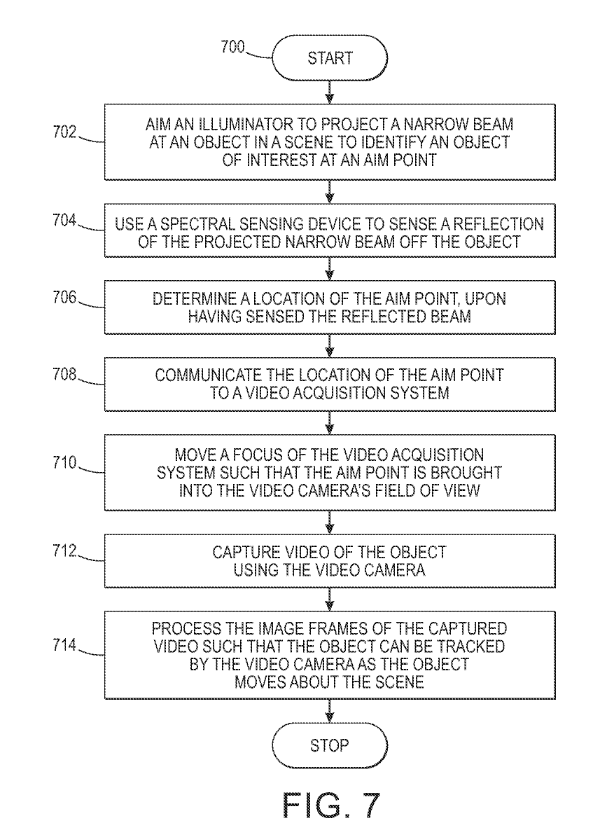

Reference is now being made to the flow diagram of FIG. 7 which illustrates one embodiment of the present method for focusing a video camera onto an object of interest identified in a scene. The method begins at step 700 and processing immediately proceeds to step 702.

At step 702, aim an illuminator at an object in a scene to identify an object of interest. The illuminator emits source light at a desired wavelength band. The source light is projected through an optical element which focuses the light into a narrow light beam. The narrow beam impacts the object at an aim point. One example illuminator is shown and discussed with respect to the system of FIG. 2. The illuminator may be a handheld which is manually pointed at the object. One such illuminator is shown and discussed with respect to FIG. 3.

At step 704, use a spectral sensing device to sense a reflection of the narrow light beam off the object. The spectral sensing device has optics for focusing reflected source light onto a detector array comprising sensors that are sensitive to a wavelength band of the emitted source light. One example spectral sensing device is shown and discussed with respect to FIG. 4.

At step 706, determine a location of the aim point in the scene in response to the spectral sensing device having sensed the reflected source light. The spectral sensing device is rotatably mounted on a controller which effectuates a movement of the spectral sensing device along a x,y,z axis. One such controller is shown and discussed with respect to controller 412 of FIG. 4. The position of the location is determined relative to a pre-determined point along a x,y,z axis and a distance the object is from the spectral sensing device. In another embodiment, the location of the aim point is determined relative to positions of known objects in the scene. In yet another embodiment, the spectral sensing device emits a pulsed signal which bounces off the object and a return signal is detected. Based upon a transit time of that signal to/from the object, a distance to the object is determined. Knowing the distance the object is from the spectral sensing device along with the x,y,z position of the controller, an instant location of the object is readily determined using well-established geometry equations. In various embodiments hereof, the spectral sensing device captures at least one spectral image of the object for processing via a pixel classification technique which effectively identifies a material comprising the object at the aim point.

At step 708, communicate the location of the aim point to a video acquisition system. The video acquisition system is rotatably mounted on a controller which effectuates a movement of the video acquisition system. One such controller is shown and discussed with respect to the video acquisition system of FIG. 5.

At step 710, move a focus of the video acquisition system such that the aim point is brought into the system's field of view.

At step 712, capture video of the object using the video acquisition system.

At step 714, process the image frames of the video such that the object is tracked by the video system as the object moves about the scene. this embodiment, further processing stops.

It should also be appreciated that the flow diagrams hereof are illustrative. One or more of the operative steps may be performed in a differing order. Other operations, for example, may be added, modified, enhanced, or consolidated. Such variations are intended to fall within the scope of the appended claims.

### Example Spectral Device Control System

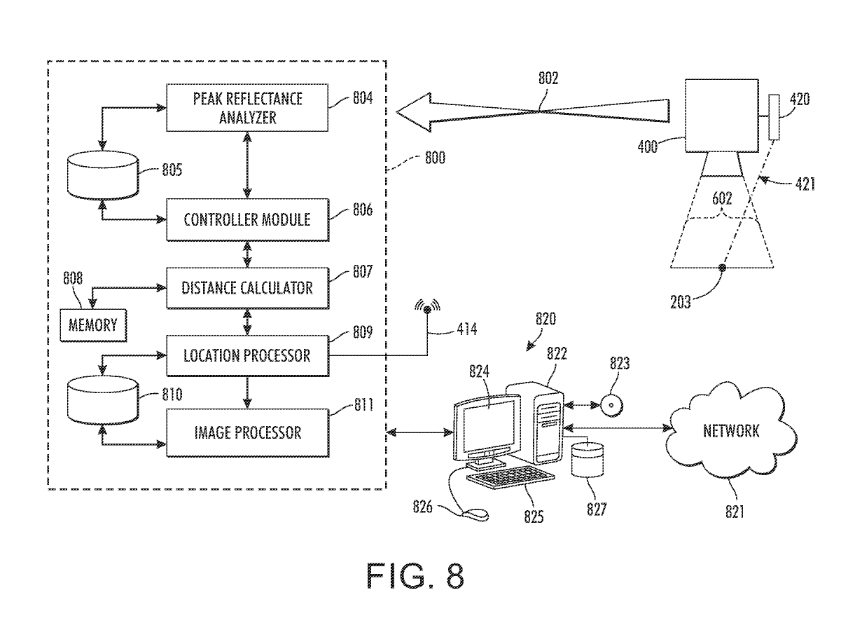

Reference is now being made to FIG. 8 which shows of a functional block diagram of the present system wherein various aspect of the present method are implemented.

In FIG. 8, spectral sensing device 400 repeatedly scans a scene waiting to sense a reflection of source light emitted by the illuminator of FIG. 3. Upon detection of a reflection of source light off, for instance, aim point 203, a signal 802 is generated and sent to Device Control Module 800 which may be internal to device 400. Peak Reflectance Analyzer 804 receives intensity levels of the detected reflected source light from the sensors in the detector array 409 of the spectral sensing device 400. Values received by the detector array are stored to storage device 805. Reflectance Analyzer 804 instructs Controller Module 806 to incrementally move the focus of the spectral sensing device 400 using, for example, a step-motor. The focus is incrementally moved in order to bring the detected aim point 203 to be approximately centered in the device's field of view 602. As the focus of the spectral sensing device is changed, Peak Analyzer 804 repeatedly receives intensity values sensed by sensors in the device's detector array. When the intensity values sensed by a pre-defined amount of sensors central in the detector array are at a high point, as determined by Peak Reflectance Analyzer 804, Controller Module 806 is then instructed to cease moving the focus of the device as it is now determined that the aim point 203 is approximately centered in the device's field of view. Controller 806 stores/retrieves positional information to storage device 805. Values and mathematical formulas are also retrieved from the storage device, as needed.

Once the Controller Module 806, operating in conjunction with Peak Reflectance Analyzer 804, has the aim point 203 approximately centered about the device's field of view 602 (as shown by way of example in FIG. 6), a signal is sent to Distance Calculator 807 to determine a distance of the aim point from device 400. Machine readable program instructions are stored in Memory 808. Calculator 807 signals, in this embodiment, pulsed light emitter 420 to emit a radar beam 421 at the aim point and detect a reflection of the beam off the object. Emitter 420 operates in a manner which is similar to, for instance, binoculars which have internal functionality for distance determination initiated upon a user thereof having placed an object in the field of view of the binocular and pressed a button thereon. A beam then is emitted at the object and reflected back. The reflection is detected by a sensor on the binocular which, in turn, proceeds to calculate a distance that object is from the user. Distance is calculated as a function of an amount of time it took the beam to go from its source, to the object, and return back to the sensor. The calculated distance to that object is displayed for the user (in feet or meters) on a screen internal to the binocular such that the user does not have to stop looking through the lens thereof to see the determined distance. Such technology is available in commerce. Golfers use these devices to ascertain a distance from their current location on the golf course to an identified object on the fairway or green.

Operating in a similar manner, Emitter 420 sends out a beam and a sensor (not shown) receives a reflection of the beam off the object and provides that round-trip time duration to Distance Calculator 807. Calculator 807 proceeds to calculate a distance the aim point 203 is from the spectral sensing device 400. The calculated distance, along with the x,y,z position obtained from the Controller Module 806, are provided to Location Processor 809. Processor 809 calculates an instant location of the aim point (and thus the object itself) using trigonometric relationships and formulas that are well understood. Variables, formulas, tables, maps of the scene with pre-defined positional points are stored/retrieved from storage device 810, as needed. Devices 805 and 810 may comprise the same storage device.

Processor 809 communicates the determined location of the aim point to one or more devices such as, for example, the video acquisition system of FIG. 5. In this embodiment, the location is communicated via Tx/Rx element 414 (antenna). The calculated location of the aim point can also be communicated to other devices. In the embodiment of FIG. 8, once the instant location of the aim point has been determined, Spectral Imager Processor 811 signals the spectral sensing device (or any other device that received the instant location of the aim point) to start acquiring or otherwise provide spectral images of the object in the scene. Image Processor 811 receives the spectral images and processes those to determine, for example, a material comprising the object. The images may be stored to storage device 810 and queued for batch processing. Processor 811, operating alone or in conjunction with other processors and memory of one or more other devices such as, for instance, workstation 820, may also process the spectral images for heart rate, perspiration, and other biometrics depending on the implementation. Processor 811 may be placed in communication with memory (not shown) which stores machine readable program instructions, data and variables, as are needed for image processing. Some or all of the functionality of system 800 may be performed entirely within device 400.

The networked system of FIG. 8 is shown further comprising a workstation 820 which is in communication with various modules and processors of Device Control Module 800. Computer case 822 houses a motherboard with a processor and memory, a communications link such as a network card, video card, and other software and hardware needed to perform the functionality of a computing system. Case 822 houses an internal hard drive capable of reading/writing to machine readable media 823 such as a floppy disk, optical disk, CD-ROM, DVD, magnetic tape, and the like. Workstation 820 further includes a display device 824, such as a CRT, LCD, or touchscreen device, for displaying information and a keyboard 825 and mouse 826 for effectuating a user input or selection. Workstation 820 has an operating system and other specialized software configured to display a wide variety of data, images, numeric values, text, scroll bars, pull-down menus with user selectable options for entering, selecting, or modifying information as desired. The workstation has an operating system and other specialized software configured to display alphanumeric values, menus, scroll bars, dials, slideable bars, pull-down options, selectable buttons, and the like, for entering, selecting, modifying, and accepting any information needed for processing the image. Software to configure a user interface or any portion thereof to display/enter/accept data is generally customizable. Any of the components of the networked workstation may be placed in communication with system 800. Any of the computational values, results, including objects, aim point, distances, locations and images can be viewed on monitor 824 wherein a user can view the displayed information and make a selection from menu options displayed thereon. A user or technician of the system of FIG. 8 may use the graphical user interface of the workstation to identify regions of interest, set parameters, use a rubber-band box to select image portions and/or regions of images for processing. These selections may be stored and retrieved from storage medium 827 or computer readable media 823. Default settings and initial parameters can be retrieved from storage device 827, as needed. Although shown as a desktop computer, it should be appreciated that workstation 820 can be a laptop, a mainframe, a client/server, or a special purpose computer such as an ASIC, circuit board, dedicated processor, or the like. The embodiment of the workstation of FIG. 8 is illustrative and may include other functionality known in the arts.

Any of the modules and processing units of FIG. 8 can be placed in communication with storage device 827 or computer readable media 823 and may store/retrieve therefrom data, variables, records, parameters, functions, machine readable/executable program instructions required to perform their intended functions. Each of the modules of system 800 may be placed in communication with one or more devices over network 821. It should be appreciated that some or all of the functionality performed by any of the modules or processing units of system 800 can be performed, in whole or in part, by workstation 820 or by a workstation placed in communication with system 800 over the network.

The embodiment shown is illustrative and should not be viewed as limiting the scope of the appended claims in any way. Although shown as a desktop computer, it should be appreciated that workstation 820 can be a laptop, tablet, mainframe, client/server, or a special purpose computer such as an ASIC, circuit board, dedicated processor, or the like. Various aspects of workstation 820, as described, are the same or substantially similar to those of the workstation FIGS. 4 and 5.

### Example Video Camera Control System

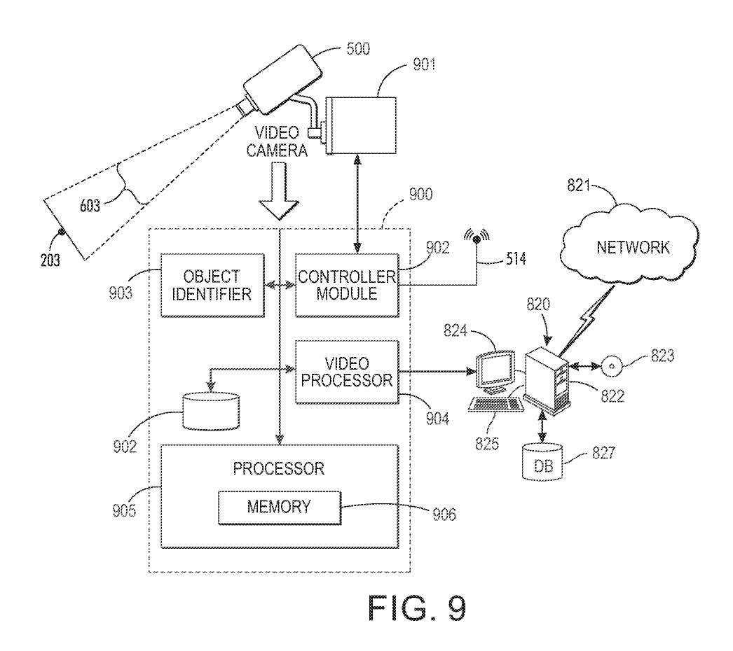

Reference is now being made to FIG. 9 which shows a functional block diagram of one embodiment of an example video control system 900 wherein various aspects of the present method are implemented.

In FIG. 9, video camera 500 is shown rotatably mounted to a motor comprising, in this embodiment, a step-motor 901. Antenna 514 receives the instant location of the aim point calculated by the Location Processor 809 of FIG. 8 and transmitted via Tx/Rx element 414 (antenna). Upon receipt of the determined instant location of the aim point, Controller Module 902 calculates an amount of movement that the video camera 500 needs to move in order to bring the aim point 203 into the camera's field of view 603. In one embodiment, the aim point is brought into the camera's field of view such that the aim point is approximately centered in the field of view. The Controller Module 902 stores various information and variables to storage device 902. It should be appreciated that some or all of the functionality of system 900 can be incorporated within the video camera 500.

Once the focus of the video camera has been moved by motor 901 such that the aim point is brought in the camera's field of view, the video camera begins acquiring video of the object of interest. Captured video images are stored to storage device 902. Video Processor Module 904, working in conjunction with Object Identifier 903, processes the captured image frames of the video to isolate the object and determine a location thereof in the scene. The location of the object is provided to Controller Module 902 which, in turn, signals motor 901 to move a focus of the video camera such that the object can be tracked as the object moves about the scene. Processor 905 retrieves machine readable program instructions from Memory 906 which facilitate processing of the video. The control system 900 is shown having been placed in communication with a workstation 820 shown and discussed with respect to FIG. 8. Any of the components of the networked workstation 820 may be placed in communication with system 900. Any of the computational values, results, video images, and the like, can be viewed on the monitor 824 wherein a user can view the displayed information and make a selection from menu options displayed thereon. A user or technician of the system of FIG. 9 may use the graphical user interface of the workstation to identify regions of interest, set parameters, use a rubber-band box to select image portions and/or regions of images for processing. These selections may be stored and retrieved from storage medium 827 or computer readable media 823.

Any of the modules and processing units of FIG. 9 can be placed in communication with storage device 827 or computer readable media 823 and may store/retrieve therefrom data, variables, records, parameters, functions, machine readable/executable program instructions required to perform their intended functions. Each of the modules of system 900 may be placed in communication with one or more devices over network 821. It should be appreciated that some or all of the functionality performed by any of the modules or processing units of system 900 can be performed, in whole or in part, by workstation 820 or by a workstation placed in communication with system 900 over the network.

It should also be appreciated that various modules of any of the systems described herein may designate one or more components which may, in turn, comprise software and/or hardware designed to perform an intended function. A plurality of modules may collectively perform a single function. Each module may have a specialized processor capable of executing machine readable program instructions for performing an intended function. A module may comprise a single piece of hardware such as an ASIC, electronic circuit, or special purpose processor. A plurality of modules may be executed by either a single special purpose computer system or a plurality of special purpose computer systems operating in parallel. Connections between modules include both physical and logical connections. Modules may further include one or more software/hardware modules which may further comprise an operating system, drivers, device controllers, and other apparatuses some or all of which may be connected via a network.

The teachings hereof can be implemented using known or later developed systems, structures, devices, and/or software by those skilled in the applicable art without undue experimentation from the functional description provided herein with a general knowledge of the relevant arts. Moreover, various aspects of the above-described systems may be partially or fully implemented in software using object or object-oriented software development environments that provide portable source code that can be used on a variety of computer, workstation, server, network, or other hardware platforms.

One or more aspects of the present method are intended to be incorporated in an article of manufacture which may be shipped, sold, leased, or otherwise provided separately either alone or as part of a product suite by the assignee or a licensee hereof. Various aspects of the methods disclosed herein may be partially or fully implemented in software using object or object-oriented software that provide portable source code that can be used on a variety of computer, workstation, server, network, or other hardware platforms. One or more of the capabilities hereof can be emulated in a virtual environment as provided by specialized programs or leverage off-the-shelf software.

It will be appreciated that the above-disclosed features and function and variations thereof may be desirably combined into many other different systems or applications. Various presently unforeseen or un-anticipated alternatives, modifications, variations, or improvements may become apparent and/or subsequently made by those skilled in the art which are also intended to be encompassed by the appended claims. The embodiments set forth above are considered to be illustrative and not limiting. Various changes to the above-described embodiments may be made without departing from the spirit and scope of the invention. The teachings of any printed publications including patents and patent applications, are each separately hereby incorporated by reference in their entirety.

What is claimed is:

1. A method for focusing a video camera onto an object of interest identified in a scene, the method comprising:
aiming an illuminator at an object in a scene to identify an object of interest, said illuminator emitting source light at a desired wavelength band, said source light being projected through an optical element which focuses said light into a narrow light beam, said narrow beam impacting said object at an aim point;
sensing, using a spectral sensing device, a reflection of said narrow light beam off said object, said spectral sensing device having optics for focusing reflected source light onto a detector array comprising sensors that are sensitive to a wavelength band of said emitted source light; and
moving a focus of a video acquisition system such that said aim point is brought into said system's field of view.

2. The method of claim 1, wherein, in response to said spectral sensing device having sensed said reflected source light, further comprising determining a location of said aim point in said scene.

3. The method of claim 1, further comprising communicating said location to said video acquisition system.

4. The method of claim 1, further comprising said video acquisition system capturing a video of said object.

5. The method of claim 4, further comprising processing said video such that object is tracked by said video acquisition system as said object moves about said scene.

6. The method of claim 1, further comprising said spectral sensing device capturing at least one spectral image of said object.

7. The method of claim 6, further comprising processing said spectral image to identify a material comprising said object.

8. The method of claim 1, wherein a movement of said spectral sensing device coincidentally moves said focus of said video acquisition system such that both move in unison.

9. The method of claim 1, wherein said illuminator comprises a handheld device which is pointed at said object to obtain said aim point.

10. The method of claim 1, wherein said spectral sensing device is rotatably mounted on a controller which effectuates a movement of said spectral sensing device.

11. The method of claim 1, wherein said video acquisition system is rotatably mounted on a controller which effectuates a movement of said video acquisition system.

12. The method of claim 1, wherein said illuminator further comprises a selectable switch which enables a selection of a wavelength band of said projected narrow beam.

13. A system for moving a focus of a video camera onto an object of interest identified in a scene, the system comprising:
an illuminator emitting source light at a desired wavelength band, said source light being projected through an optical element which focuses said light into a narrow beam, said narrow light beam impacting an object of interest at an aim point;
a spectral sensing device for sensing a reflection of said narrow light beam off said object, said spectral sensing device having optics for focusing reflected source light onto a detector array comprising sensors that are sensitive to a wavelength band of said emitted source light; and
a controller upon which a video acquisition system is rotatably mounted, said controller moving a focus of said video acquisition system such that said aim point is brought into a field of view of said video acquisition system.

14. The system of claim 13, further comprising a processor for determining a location of said aim point in said scene.

15. The system of claim 14, wherein, in response to said spectral sensing device having sensed said reflected source light and said processor having determined said location, further comprising communicating said location to said controller.

16. The system of claim 13, further comprising said video acquisition system capturing a video of said object.

17. The system of claim 16, further comprising processing said video such that object is tracked by said video acquisition system as said object moves about said scene.

18. The system of claim 13, further comprising said spectral sensing device capturing at least one spectral image of said object.

19. The system of claim 18, further comprising processing said spectral image to identify a material comprising said object.

20. The system of claim 13, wherein said illuminator comprises a handheld device which is pointed at said object to obtain said aim point.

21. The system of claim 13, further comprising a second controller upon which said spectral sensing device is rotatably mounted, said second controller moving a focus of said spectral sensing device such that said aim point is brought into a field of view of said spectral sensing device.

22. The system of claim 21, wherein a movement of said second controller coincidentally moves said focus of said video acquisition system such that both move in unison.

23. The system of claim 13, wherein said illuminator further comprises a selectable switch which enables a selection of a wavelength band of said projected narrow beam.
